(19) United States
(12) Patent Application Publication
(10) Pub. No.: US 2004/0031563 A1
(43) Pub. Date: Feb. 19, 2004

(54) Fabric joing by fibre encapsulation

(76) Inventor: Robert Clark, Midlothian (GB)

Correspondence Address: FLESHNER & KIM, LLP, P.O. BOX 221200, CHANTILLY, VA, 20153, US

(21) Appl. No.: 10/240,210

(22) PCT Filed: Apr. 2, 2001
(86) PCT No.: PCT/GB01/01497

(30) Foreign Application Priority Data
Mar. 31, 2000 (GB) 0007716.4

(51) Int. Cl. B32B 31/00

(52) U.S. Cl. 156/290; 156/295; 156/578; 156/582

(57) ABSTRACT

A method of joining fabric sheets is disclosed, wherein a thermoplastic joiner is impregnated into a fabric sheet. The molten adhesive is applied to the fabric and may be made to impregnate the fibres by a combination of a roller (16), and infrared source (7), and an ultrasound head (5). The method enables otherwise non-containable fibres (2) to he contained, thereby providing a strong, leakproof seam. In another embodiment, the roller is shaped in order to provide a self locating bead profile, to improve the alignment process.

The present invention relates to the field of fabric Joining technologies. In particular, it relates to methods of joining and laminating fabric sheets made from non-containable material such as aramid fibres and fleeces.

The term non-containable refers herein to materials which cannot be sufficiently thoroughly penetrated by suitable adhesives using practicable pressures and bonding conditions to give a leakproof seal, typically because the fabric is too thick to be penetrated or because the interstices of the fabric do not connect through the fabric layer to allow molten adhesive to flow through. Example non-containable materials are aramid fibres such as para-amide (e.g. XEVLAR®, TWARON®) or other industrial needle felts such as viscose, polypropylene, meta-aramide (erg. NOMEX®), polyamide, polyacrylnitrile, polyester, polyamidimide. Another important class of non-containable materials are those fibrous materials sold under the Thinsulate® brand e.g. polyester/olefin fibrous fabrics. Needlefelts in general and also carbon fibre products are also included. Sometimes sheets of non-containabl materials are provided with scrims which may be wat rproof or non-waterproof plastic layers, aluminium etc.

At the present time there is a large world-wide market in specialist articles of clothing which have properties such as being flame resistant or heat resistant. Within these articles of clothing, many of the materials with the most appropriate properties, such as aramid fibre, are non-containable. This makes them difficult to use, particularly in applications such as waterproof products where a waterproof, strong seal is required.

PCT Application No WO99/64240 to Liteliner LLC discloses a method of forming leakproof seams between non-containable fabrics wherein a thermoplastic joiner layer is placed in register between non-containable fabric layers, melted in situ where it forms a strong bond after which the resulting composite is trimmed. In WO99/64240, non-containable fabric layers are covered with synthetic membranes which are also sealed together. We have found that this joining technology is useful for all manner of non-containable fabrics with or without synthetic membranes, with synthetic membranes as separate layers or as scrims and, when there are membranes, with breathable and non-breathable synthetic membranes.

This technology provides very strong joins, but can be difficult to use for gloves which need to tolerate high temperatures. For example, gloves in the fire industry must withstand temperatures well in excess of 100° C.; however, thermoplastic films with melting temperatures above around 80° C. have been found by us to be hard to use in forming these products as it is difficult to get them to melt in situ and form an appropriate strength bond within the constraints of industrial manufacturing. Therefore, the aim of the present invention is to provide a method for joining non-containable fabric materials to each other which is better adapted for use in high temperature applications.

Furthermore, when using the sealing technique disclosed in WO99/64240 it is necessary to take great care to keep the various layers, including the joiner layer, in register. The thermoplastic joining films of the prior art are particularly difficult to align correctly, since they are prone to static electricity, causing them to cling to equipment and handlers. Esther, once the film is in position, it is not easy to maintain the correct position of the film.

It would be advantageous to provide a method of joining fabrics that requires fewer sheets to be aligned. It would also be advantageous to provide a method of forming a multilayered product where less accuracy in alignment was required.

According to a first aspect of the present invention there is provided a method of joining first and second fabric sheets, the method comprising the steps of: impregnating a joining region of a first sheet with a thermoplastic joiner, placing the joining region of the first sheet in contact with a joining region of a second sheet, and applying heat to the joining regions so as to cause the thermoplastic joiner to melt, thereby joining the joining regions.

Preferably, the first and second sheets are non-containable.

Preferably, the first sheet is a fibrous material.

More preferably, the first sheet is aramid.

In one embodiment, the method further comprises the step of impregnating the joining region on the second sheet with thermoplastic joiner, before the application of heat to the joining regions.

The joining regions of the first sheet and/or the second sheet may be impregnated with thermoplastic joiner by applying molten thermoplastic joiner and ultrasound energy to the surface.

Preferably, infra-red energy will be applied to the region which is to be joined simultaneously with the application of ultrasound energy so as to help keep the thermoplastic joiner molten.

The regions to be joined may be impregnated by making a plurality of indentations in the sheets and encouraging molten thermoplastic joiner to flow into the indentations.

The first and second sheets may be composites.

According to a second aspect of the invention there is provided a method of joining first and second fabric sheets, the method comprising the steps of: applying an adhesive to a joining region of a first sheet so a bead of adhesive remains protruding from a surface of the joining region; shaping said protruding bead such that it is given a s lf-locating profile corresponding to a joining region on the second sheet; and placing the joining region of the first sheet in contact with a joining region of the second sheet.

In one embodiment, the method comprises the additional steps of: applying an adhesive to a joining region of a second sheet so that a bead of adhesive remains protruding from a surface of the joining region; shaping said protruding bead such that it is given a self-locating profile corresponding to the self-locating profile of the protruding bead on the joining region of the first sheet.

The self locating profile of the bead on the first sheet may be the same as the self-locating profile of the bead on the second sheet. Alternatively, the self-locating profile on the second sheet may compliment the shape of the bead on the first sheet.

Preferably, the adhesive is a thermoplastic joiner.

More preferably, the thermoplastic joiner is at least partially impregnated into the joining region of the first sheet and/or second sheet.

The joining regions of the first sheet and/or the second sheet may be impregnated with thermoplastic joiner by applying molten thermoplastic joiner and ultrasound energy to the surface.

The method may further include the step of rolling the adhesive subsequent to its application, said rolling step providing the bead with said self-locating profile.

According to a third aspect of the invention there is provided apparatus for joining first and second sheet materials sheets, comprising means for applying an adhesive to a joining region of a first sheet so that a bead of adhesive remains protruding from a surface of the joining region; means for shaping said protruding bead such that it is given a self-locating profile corresponding to a joining region on the second sheet; and means placing the joining region of the first sheet in contact with a joining region of the second sheet.

The shaping means may be a roller. The roller may have a recessed channel in order to shape the bead of adhesive.

The apparatus may include means for impregnating the adhesive into the sheet. Preferably the impregnating means is an ultrasound sonotrode.

An example embodiment of the present invention will now be illustrated with a reference to the following figures in which:

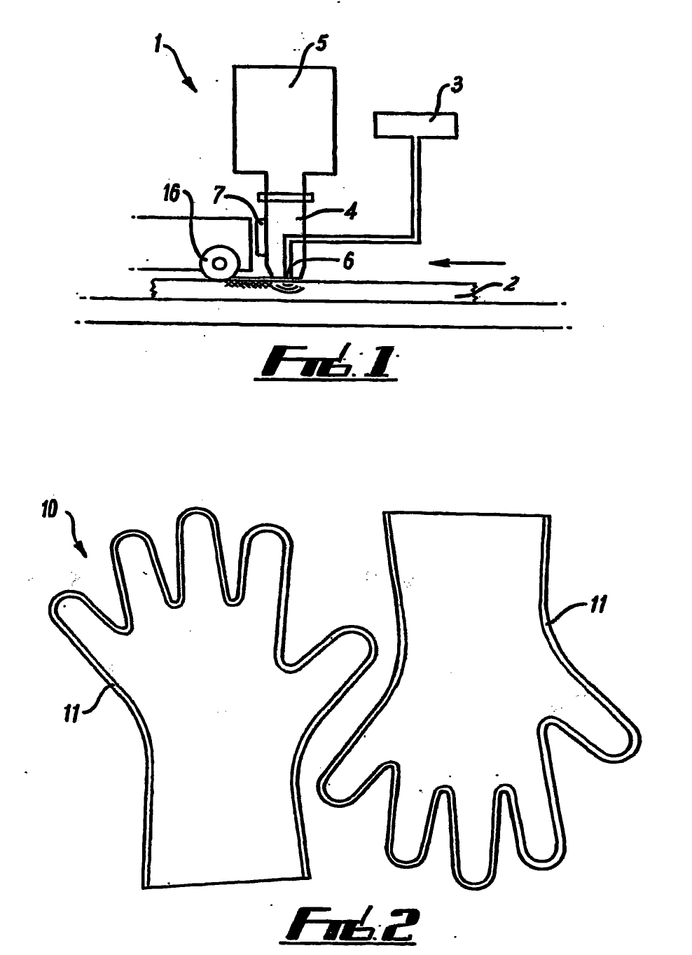

FIG. 1 shows a cross-section through a fibre-encapsulation device;

FIG. 2 shows a plate for use in forming glove shaped garments.

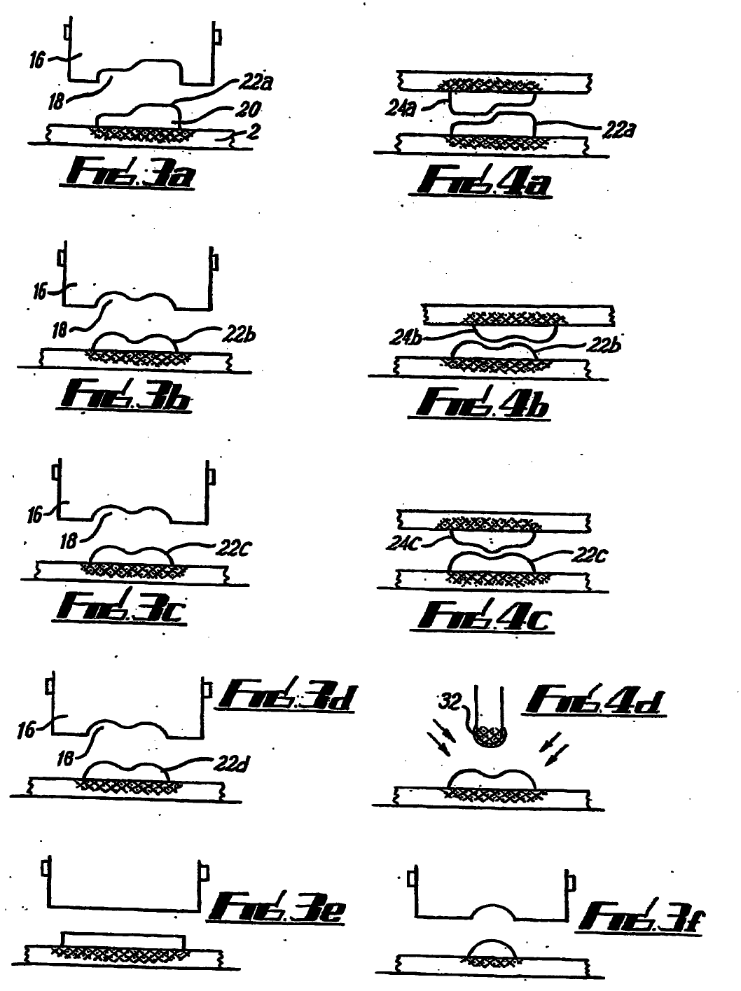

FIG. 3 shows cross-sectional views of shaped rollers for providing a self-locating profile to beads according to one embodiment of the invention.

FIG. 4 shows cross sectional views of bead profiles being brought into contact with one another.

FIG. 1 shows a cross-section through a fibre encapsulation device 1. This apparatus is an improved version of the apparatus disclosed in PCT/GB99/00758 to Rosslyn Precision Limited adapted also in that it caters for encapsulation of fibres on any surface of a non-containable fabric rather than being preferably applied to butt joins.

This technique is for use with a non-containable fibrous material such as aramid. These fabric sheets may be joined to other similar sheets. It has been found that adhesive supplied by an adhesive pump 3 can be impregnated into an otherwise non-containable fibre 2 using an ultrasound sonotrode 4. In the present example a half-kilowatt ultrasound head 5 is used to provide ultrasound to the surface of the fabric and adhesive is fed in a molten state through the centre of the sonotrode onto the fabric surface at 6. Furthermore, an infrared source 7 may be optionally provided to heat the area in which adhesive is fed, thereby keeping the adhesive molten longer and allowing it to penetrate further into the fabric. The IR source allows the temperature to be controlled precisely in order that the flow characteristics of the particular adhesive used can be optimised. The adhesive will typically be a thermoplastic material selected for its melting point.

There is optionally provided a roller 16, positioned so that the bead-of thermoplastic joiner is rolled subsequent to its application. The roller provides additional impregnation, and may shape the bead of adhesive. The roller is coated with a layer of PTFE in order to prevent it from sticking to the adhesive.

This process has encapsulated the fibres within the treated fabric with adhesive. Without the hot adhesive and ultrasound combination of the present invention, it would not be possible to fully contain these materials. Once the fibres have been encapsulated, pieces of impregnated fabric may be joined by simply placing them in contact with each other and heating the junction so as to melt the thermoplastic.

The ultrasound monotrode may be passed along the edge of the fabric or across the face of fabric to encapsulate it. A numerically controlled coordinate table may be used. Alternatively, fabric may be moved past the sonotrode or the sonotrode may be configured to encapsulate a wide area of the fabric at once.

Impregnated fabrics may therefore be joined with this technology and in particular with lap joints or face-to-face joints. In addition, a ‘T-joint’ may be provided for use in, for example, chambered products such as inflatable garments and life rafts.

Once the aramid has been impregnated with thermoplastic adhesive by this method, sheets of it may be joined to each other by an easier and more conomic method than that disclosed in U.S. Pat. No. 5,766,400 and WO 98/09911 to Liteliner.

Thermoplastic impregnated fabric layers may then be placed in contact with each other and heated using RF, ultrasound, infrared, direct thermal contact with a heater or any other heating technique.

For example, FIG. 2 shows an outline of a glove cutout. Such glove shapes can be encapsulated around their margins in the border region 11. The two corresponding hand shaped pieces can then be placed in contact with each other, with the encapsulated regions in direct contact. The encapsulated regions can then be heated and a platen press applied. The press may also have a cutting die to cut the material in the same step.

It is possible to encapsulate two fabrics layers separately and then join them or, alternatively, to encapsulate and join them in a single heating step.

Various modifications of the above process are envisaged. For example, it should be noted that the use of infra red sources, ultrasound heads, and rollers for impregnation of the adhesive is independent, and may be provided either in combination or separately. Each contribute to the encapsulation of the fibres in the fabric in its own way, but it may only be necessary to provide one or two of these devices.

This technique may also be applied in the same way to join layers of fleece type material and to join different types of material to each other. Importantly, it can also be used to join composite fabrics together, where the composite fabrics have a non-containable surface sheet. For example, the technique could be used to join composites having a waterproof breathable layer within them by joining non-containable surface sheets to each other.

The benefits of this invention in comparison with U.S. Pat. No. 5,766,400 to the Liteliner are several fold. Firstly, not having to put a thermoplastic joining film in register with the other fabric materials during the assembly stage reduces the cost of the process. Secondly, the amount of waste material is significantly reduced, further reducing the cost.

Thirdly, the alignment process is simplified by virtue of using fewer sheet materials. The use of problematic joiner films which are prone to static is avoided, making the manufacturing process easier and faster.

In addition, a thermoplastic material with a higher melting point can be used. This is because in U.S. Pat. No. 5,766,400 heat must pass through several layers of material to melt the thermoplastic joining film and must also penetrate through the thickness of the joining film itself. This is particularly difficult to achieve rapidly when using materials such as aramid fibre which are, in fact, designed to have a high heat capacity.

In the present application not only must heat penetrate through a smaller distance as there is not the additional gap caused by a thermoplastic joining film but the thermoplastic material which is encapsulated around the fibres can itself conduct heat thereby making it much easier for an external heating source to penetrate the join and, as a result, making it easier to use a higher melting point thermoplastic as the adhesive. This is particularly important when joining along a seam where it is important to melt the thermoplastic joiner quickly. Another benefit is the reduced bonding time required, making the overall process substantially faster.

This technique can then be used in the construction of multi-layered articles such as gloves, boots, jackets, trousers etc.

Instead of using ultrasound to encapsulate the fibres, thermoplastic material may instead be impregnated within non-containable (or indeed, any) fabric by physically puncturing the surface or using a fine ultrasound beam or laser to make microholes in the surface into which molten thermoplastic material can flow. These impregnated sheets can then be joined by aligning the impregnated regions and heating in the same manner as above.

It will be clear to one skilled in the art that the fibre encapsulation joining techniques disclosed above will have wide applicability wherever non-containable fibres are used.

There will now be described a method according to a further embodiment of the invention, with reference to FIGS. 3 and 4 in particular.

FIG. 1 shows a cross-section through a device for providing a bead of adhesive to a fabric sheet. Molten adhesive is applied from adhesive pump 3 via a channel, and is fed onto the fabric surface at 6. Infra red source 7 and ultrasound apparatus may optionally be provided at 4 and 5. Roller 16 is provided to roll the bead of adhesive subsequent to its application at 6. The roller at least partially impregnates the adhesive into the fabric, and in addition shapes the bead of adhesive in accordance with the second aspect of the invention.

FIGS. 3e and 3f show standard rollers, and FIGS. 3a to 3d show cross-sections of various rollers which may be used in the method according to the invention.

The roller 16 contains a recessed channel 18. When the roller is passed over the fabric and adhesive, some of the adhesive is impregnated into the fabric 2, whilst some of the adhesive is channelled into region 18, remaining on the surface as a protruding bead 20. An appropriate volume of adhesive is used so that the bead conforms to the shape of the profile of the channel 18, as shown in FIGS. 3a to 3d.

In this embodiment the bead is shaped in the form of a stepped mound 22a. A second fabric sheet to be bonded to the first sheet undergoes an identical process, so that a bead 24a with an identical profile is provided. When the second sheet is inverted to be placed on the first sheet, as shown in FIG. 4a, it can be seen that the profiles of the beads correspond with one another. The stepped mound provides a self-locating bead profile, so that the fabrics are joined in the correct position. It can be seen that if the upper fabric of adhesive is misaligned slightly to the left, the profile of the beads will naturally guide the upper sheet to the left. Additionally, if the upper sheet is slightly misaligned to the right, the lower portions of the mounds will correspond to one-another, with the upper portion of the mounds resting against th surface of the opposing fabric.

The joining step may take place when the adhesive is in a molten or semi-molten form, with the molten state being maintained by heating means (such as an IR source). Alternatively, the adhesive may be left to solidify before the fabrics are placed in contact with one-another, with a heat source or ultrasound source remelting the adhesive when its in position.

An alternative arrangement is depicted in FIGS. 3b and 4b. Here, the roller is shaped to form a bead profile with a double hump. The adhesive bead on the second sheet is formed to be the same shape.

A further self-locating profile is depicted in FIGS. 3c and 4c. In this embodiment, the bead on the second sheet is not given the same profile as the bead on the first sheet. Rather, a second roller is used in order to provide a bead shape that compliments that of the first This arrangement allows self-location from the right and the left sides, with almost complete contact between the two adhesive beads.

The above roller shapes and bead profiles, and other modifications, are particularly suitable for lap joints and face-to-face joints.

The arrangement of FIGS. 3d and 4d is particularly suitable for ‘T’ joints, which may be used in the production of chambered articles. In this embodiment, the first sheet is provided with a double hump self-locating profile, as shown in FIG. 3d. The second sheet is provided with adhesive along its edge 32, which is then lowered into contact with the first bead so that the two fabric sheets are perpendicular to one-another, as shown in FIG. 4d. Subsequently, heat, rollers, or a combination of the two is applied to the join along each side of the second material, in order to smooth down the protruding adhesive.

This joining method allows two fabrics to be more easily aligned by providing a self-locating bead profile. Less precise alignment is required, simplifying the manufacturing process and thereby reducing its cost. The method has the added advantage that secure T-joints are possible. Further, it is possible to shape the adhesive beads in this way in order to add aesthetic value to visible seams, quite apart from the improved join that results.

It is evident that the joining method of the second aspect of the invention could be used in combination with the first aspect, for bonding non-containable fibres. By first ensuring impregnation of the adhesive into the fibres, by ultrasound techniques or otherwise, it is possible to provide containing joins with the self-locating bead profile techniques.

Further modifications may be made within the scope of the invention herein described.

1. A method of joining first and second fabric sheets, the method comprising the steps of: impregnating a joining region of a first sheet with a thermoplastic joiner, placing the joining region of the first sheet in contact with a joining region of a second sheet, and applying heat to the joining regions so as to cause the thermoplastic joiner to melt, thereby joining the joining regions.

2. A method as claimed in claim 1, wherein the first and second sheets are non-containable.

3. A method as claimed in. Claim 1 or claim 2, wherein the first sheet is a fibrous material.

4. A method as claimed in any preceding claim, wherein the first sheet is aramid.

5. A method as claimed in any preceding claim, wherein the method further comprises the step of:
impregnating the joining region on the second sheet with thermoplastic joiner, before the application of heat to the joining regions.

6. A method as claimed in any preceding claim, wherein the Joining regions of the first sheet and/or the second sheet are impregnated with thermoplastic joiner by applying molten thermoplastic joiner and ultrasound energy to the surface.

7. A method as claimed in any preceding claim, wherein infra-red energy is applied to the region which is to be joined simultaneously with the application of ultrasound energy.

8. A method as claimed in any preceding claim, wherein the regions to be joined are impregnated by making a plurality of indentations in the sheets and encouraging molten thermoplastic joiner to flow into the indentations.

9. A method as claimed in any preceding claim, wherein first and second sheets are composites.

10. A method of joining first and second fabric sheets, the method comprising the steps of:
applying an adhesive to a joining region of a first sheet so a bead of adhesive remains protruding from a surface of the joining region;
shaping said protruding bead such that it is given a self-locating profile corresponding to a joining region on the second sheet; and
placing the joining region of the first sheet in contact with a joining region of the second sheet.

11. A method as claimed in claim 10, wherein the method comprises the additional steps of:
applying an adhesive to a joining region of a second sheet so that a bead of adhesive remains protruding from a surface of the joining region;
shaping said protruding bead such that it is given a self-locating profile corresponding to the self-locating profile of the protruding bead on the joining region of the first sheet.

12. A method as claimed in claim 10 or claim 11, wherein the self locating profile of the bead on the first sheet is the same as the self-locating profile of the head on the second sheet.

13. A method as claimed in claim 10 or claim 11, wherein the self-locating profile on the second sheet compliments the shape of the bead on the first sheet.

14. A method as claimed in any of claims 10 to claim 13, wherein the adhesive is a thermoplastic joiner.

15. A method as claimed in any of claims 10 to claim 13, wherein the thermoplastic joiner is at least partially impregnated into the joining region of the first sheet and/or second sheet.

16. A method as claimed in any preceding claim wherein the joining regions of the first sheet and/or the second sheet is impregnated with thermoplastic joiner by applying molten thermoplastic joiner and ultrasound energy to the surface.

17. A method as claimed in any of claims 10 to claim 16, wherein further includes the step of rolling the adhesive subsequent to its application, said rolling step providing the bead with said self-locating profile.

18. An article manufactured by a method as claimed in any preceding claim.

19. Apparatus for joining first and second sheet materials sheets, comprising: means for applying an adhesive to a joining region of a first sheet so that a bead of adhesive remains protruding from a surface of the joining region; means for shaping said protruding bead such that it is given a self-locating profile corresponding to a joining region on the second sheet; and means for placing the joining region of the first sheet in contact with a joining region of the second sheet.

20. Apparatus as claimed in claim 19, wherein the shaping means is a roller.

21. Apparatus as claimed in claim 20, wherein the roller has a recessed channel in order to shape the bead of adhesive.

22. Apparatus as claimed in any of claims 19 to 21, wherein the apparatus includes means for impregnating the adhesive into the sheet.

23. Apparatus as claimed in claim 22, wherein the impregnating means is an ultrasound sonotrode.
